(19) United States
(12) Patent Application Publication
(10) Pub. No.: US 2025/0059060 A1
(43) Pub. Date: Feb. 20, 2025

(54) HIGH TEMPERATURE-PHASE NIOBIUM PENTOXIDE (H-NB2O5) BASED ELECTRODES FOR HIGH-POWER LITHIUM-ION (US NP)

(71) Applicant: Georgia Tech Research Corporation, Atlanta, GA (US)

(72) Inventors: Meilin Liu, Atlanta, GA (US); Tongtong Li, Atlanta, GA (US); Gyutae Nam, Atlanta, GA (US); Bote Zhao, Atlanta, GA (US)

(21) Appl. No.: 18/720,477

(22) PCT Filed: Jan. 18, 2023
(86) PCT No.: PCT/US23/10983

§ 371 Date: Jun. 14, 2024

Related U.S. Application Data
(60) Provisional application No. 63/300,464, filed on Jan. 18, 2022.

(51) Int. Cl. C01G 33/00; H01M 4/02; H01M 4/04; H01M 4/1391; H01M 4/62; H01M 4/66

(52) U.S. Cl. CPC C01G 33/00; H01M 4/0404; H01M 4/1391; H01M 4/623; H01M 4/661; C01P 2002/72; C01P 2002/82; C01P 2002/88; C01P 2004/03; C01P 2006/40; H01M 2004/027

(57) ABSTRACT

In a method of making an electrode, a binder is dissolved in a solvent to form a solution. An Nb₂O₅ hydrate-based electrode material powder is suspended in the solution to form a slurry. A predetermined thickness of the slurry is dispensed onto a conductive member so that the slurry has a mass loading in a range of 1 mg cm⁻² to 2 mg cm⁻². The conductive member and the slurry are dried to form the electrode. A battery includes an anode, a cathode, an electrolyte and a separator. The anode includes a graphite-modified Nb₂O₅ composite electrode material powder applied to a conductive member. The electrolyte is in electrical communication with the anode and the cathode. The separator is permeable to the electrolyte and is disposed between the anode from the cathode.

### CROSS-REFERENCE TO RELATED APPLICATION(S)

This application claims the benefit of U.S. Provisional Patent Application Ser. No. 63/300,464, filed Jan. 18, 2022, the entirety of which is hereby incorporated herein by reference.

### BACKGROUND OF THE INVENTION

### 1. Field of the Invention

The present invention relates to electrodes and, more specifically, to H—Nb₂O₅ and graphite-modified Nb₂O₅ composite electrodes.

### 2. Description of the Related Art

The demand for portable devices and electric vehicles is driving the development of new-generation lithium-ion batteries (LIBs) with faster charging capability and longer lifespan. It is desirable that electric vehicles be fully charged within just a few minutes, so as to be competitive with conventional gasoline vehicles. Thus, substantial effort has been devoted to the development of new materials with high-rate electrochemical energy storage capability. Among several candidates, Li₄Ti₅O₁₂ (LTO) is one of the most promising high rate anodes for LIBs. However, owing to several serious drawbacks of LTO, such as relatively low capacity and a gassing problem that can result in degradation, use of LTO has not been widely accepted in the commercial market.

Recently, niobium-based materials, such as niobium pentoxide, niobium tungsten oxide and titanium niobium oxide, have exhibited fast lithium storage capability when employed as the anode of a battery. These niobium-based materials are electrochemically active in a similar operating voltage of LTO but have a higher specific capacity. In terms of the crystal structure, these niobium-based materials can be divided to two categories, a bronze structure represented by T-phase (orthorhombic) Nb₂O₅, and a Wadsley-Roth crystallographic shear (CS) structure represented by H-phase (monoclinic) Nb₂O₅. However, a H—Nb₂O₅ anode with a high rate capability has yet to be reported. Such an electrode would be unlike T-phase electrodes that exhibit intrinsic fast Li intercalation even for bulk materials through a pseudo-capacitive mechanism.

The development of anode materials with high rate capability is critical to high-power lithium batteries. The T-phase of niobium pentoxide (Nb₂O₅) has been widely reported to have unique pseudo-capacitive behavior and fast lithium storage. However, the other polymorphs of Nb₂O₅ prepared at higher temperatures have the potential to deliver higher rate capability and greater tap density than the T-phase Nb₂O₅, offering higher volumetric power and energy density.

High sintering temperatures that H—Nb₂O₅ usually exhibit in large particles make it hard to be modified by using existing technology. The electrochemical behavior of H—Nb₂O₅ is being studies systematically to have a better understanding the charge storage mechanism. It has been found that the initial capacity of H—Nb₂O₅ at a low rate is much higher than T-Nb₂O₅ and is superior to its ternary counterpart (Nb₁₆W₅O₅₅), which is considered to be the state-of-the-art high rate materials. Exploring whether H—Nb₂O₅ possesses high rate capability, and using its abundant active sites to their full potential by modifying the morphology may be the key to developing advanced electrode materials using H—Nb₂O₅.

Therefore, there is a need for a high rate high temperature shear phase Nb₂O₅ and its derivatives (non-stoichiometric compounds and the composites) electrode materials.

### SUMMARY OF THE INVENTION

The disadvantages of the prior art are overcome by the present invention which, in one aspect, in one aspect, is a method of making an high temperature monoclinic phase Nb₂O₅, named as H—Nb₂O₅, with enhanced capacity. H—Nb₂O₅ with planar defects to some extent is prepared at temperature region from 950 C to 1100 C. An electrode comprising H—Nb₂O₅-based materials prepared at this temperature region shows superior rate performance.

In another aspect, the invention is a method of making an electrode, in which a binder is dissolved in a solvent to form a solution. An Nb₂O₅ hydrate-based electrode material powder is suspended in the solution to form a slurry. A predetermined thickness of the slurry is dispensed onto a conductive member so that the slurry has a mass loading in a range of 1 mg cm⁻² to 2 mg cm⁻². The conductive member and the slurry are dried to form the electrode.

In yet another aspect, the invention is a battery that includes an anode, a cathode, an electrolyte and a separator. The anode includes a graphite-modified Nb₂O₅ composite electrode material powder applied to a conductive member. The electrolyte is in electrical communication with the anode and the cathode. The separator is permeable to the electrolyte and is disposed between the anode from the cathode.

The anode includes a graphite-modified Nb₂O₅ composite electrode materials powder, where graphite was applied to a conductive member, constraining the growth of Nb₂O₅ particles and producing non-stoichiometric Nb₂O₅ compounds as well.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1a shows Thermogravimetric analysis (TGA) and differential scanning calorimetry (DSC) of Nb₂O₅ hydrate heated from 25 to 1000° C. at 5° C. min⁻¹ under flowing air at 20 mL min⁻¹.

FIG. 1b shows XRD patterns of phases observed upon heating Nb₂O₅ hydrate in air at different temperatures. The standard PDF pattern for T-(orthorhombic) and H-(monoclinic) phase are inserted at the bottom and top of the graph, respectively.

FIG. 1c shows Raman spectra of phases observed upon heating Nb₂O₅ hydrate in air.

FIG. 1d-1f are micrographs of three typical characteristic Raman active mode for Nb₂O₅ are highlighted by brilliant blue background. SEM images of Nb₂O₅ prepared at: (FIG. 1d) 700° C., (FIG. 1e) 950° C. and (FIG. 1f) 1300° C.

FIG. 2 is a plurality of SEM images showing a mixture of Nb₂O₅ and graphite after ball milling and of the composite after calcination.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

A high-performance H—Nb₂O₅ anode is prepared by calcination of niobium pentoxide hydrate at a sufficient temperature (e.g. from 950° C. to 1100° C.), which possess planar defects to some degree depending temperature and shows a much higher specific capacity and better rate capability than T-Nb₂O₅.

A composite electrode composed of Nb₂O₅ and graphite is further prepared using a simple ball milling process. The addition of graphite improves the conductivity of overall electrode and confines the particle size of Nb₂O₅, which confines the particles size of the metal oxides and produce non-stoichiometric Nb₂O₅. The composite electrode delivered a much higher capacity than most of the recently reported Nb-based oxides and composite electrodes. In addition to the excellent electrochemical performance, the fabrication process of the H—Nb₂O₅ and the composites can be readily scaled up at low cost, implying that the H—Nb₂O₅ based composite electrodes are ideally suited for next-generation fast-charging batteries.

A high temperature phase niobium pentoxide (H—Nb₂O₅) and graphite-modified Nb₂O₅ prepared at similar temperature were as high-performance anode materials for LIBs. H—Nb₂O₅ shows a higher performance compared to T-Nb₂O₅ and its electrochemical performance is further improved by controlling morphology through variation of temperature. H—Nb₂O₅ delivers a comparable performance to its ternary derivatives (niobium tungsten oxide) and its graphite composite anode materials exhibited significantly enhanced electrochemical performance in terms of specific capacity, rate capability and durability, superior to those of the state-of-the-art niobium-based anode materials and composites.

In one experimental embodiment, different phase of Nb₂O₅, Nb₂O₅ hydrate powder (available from CBMM Company) were placed in alumina crucibles and calcined at a desired temperature for 3 hours with a ramp rate of 5° C. min⁻¹ in a box furnace in air. To obtain the graphite-modified Nb₂O₅ composite, 0.24 g Nb₂O₅ hydrate with the desired amount of graphite (available from Aldrich) was first ball milled at 500 rpm for 2 h in a planetary ball mill (available from PULVERISETTE, 7 premium line). Then the mixture was calcined at 950° C. in a tube furnace under an Ar atmosphere with a ramp rate of 5° C. min⁻¹. H—Nb₂O₅ (950° C. Ar) was prepared in a tube furnace under Ar in the same condition.

In preparing electrodes, the binder (such as PVDF) was first dissolved in 1-methyl-2-pyrrolidone (NMP, available from Sigma-Aldrich, 99.5%, anhydrous). The anode slurry was prepared by hand grinding active material (Nb₂O₅) with carbon (SUPER P Li, available from TIMCAL) and binder as the mass ratio of 8:1:1 in a mortar. Then the slurry was dispensed on a copper foil and doctor-bladed to 20 μm for a mass loading of active materials between 1 mg cm⁻² to 2 mg cm⁻². The foil was first dried in a drying oven in air at 70° C. for 30 minutes then transferred into a vacuum oven at 90° C. for about eight hours. The electrodes were then punched to 10 mm diameter and transferred to an argon-filled glovebox for assembling.

The electrolyte used was 1.0 M lithium hexafluorophosphate (LiPF₆) in ethylene carbonate/dimethyl carbonate (EC/DMC, 1:1 by volume) solution (available from Sigma-Aldrich). A glass microfiber (VWR) was used as a separator and metallic Li (MTI) was used as both reference and counter electrode. The resulting half-cells (of the size of a CR2032 coin type cell) were used for battery tests. Electrochemical tests were carried out by using 8-channel Neware battery system (CT4008) at room temperature of 23° C. The charge-discharge was examined by constant current charging without voltage hold. GITT experiments were measured with a current density of C/10 (20 mA g⁻¹), a current pulse of 0.5 h, and a rest step of 12 h to reach quasi-equilibrium potential. D_{Li}L⁻² value instead of D_{Li} was extracted by following equation to eliminate the effect of circuitry of the electrode.

$$= \frac{4}{π \times τ} \cdot {L}^{2} \cdot {( \frac{Δ {E}_{s}}{Δ {E}_{t}} )}^{2}$$

where τ is the duration of the current pulse, L is the diffusion length, ΔE_{S} is the change in steady-state potential, ΔEₜ is the total change of the cell voltage during the current pulse after removing the ohmic loss.

Thermal gravimetric analysis (TGA) was performed on Q600 SDT from TA Instruments. Nb₂O₅ hydrate was heated from 25 to 1000° C. at 5° C. min⁻¹ under flowing air at 20 mL min⁻¹. The ramp rate is consistent with the synthesis of pure Nb₂O₅. For calculating the carbon content of the graphite modified Nb₂O₅ composite, the samples were heated from 25 to 800° C. at 10° C. min⁻¹ under flowing air at 20 mL min⁻¹.

Raman spectroscopic measurement was performed using a Renishaw RM1000 microspectroscopic system with a 50× objective and an Ar laser excitation (514 nm). Every spectrum was acquired over a collection time of 60 s with two accumulations. X-ray Diffraction (XRD) patterns of samples were recorded at room temperature using an X'Pert PRO Alpha-1 X-ray diffractometer with a Cu Kα radiation source. Patterns were recorded from 8-80° 2θ in steps of 0.008° 2θ. The sketch of the crystal structure was generated using CrystalMaker® CrystalMaker Software Ltd, Oxford, England. Scanning electron microscopy (SEM) analysis was performed on a Hitachi SU8010 SEM with a beam voltage of 15 kV.

Investigation into the effect of calcination temperature of Nb₂O₅ hydrate (from CBMM) on the crystal structure and morphology of Nb₂O₅:Nb₂O₅ can be exist in the amorphous state or in one of many different crystalline polymorphs depending on the synthesis methods, precursors and pyrolysis temperatures. T-Nb₂O₅ usually appears when NbO₂, amorphous Nb₂O₅, TT-Nb₂O₅ or some niobic acid is heated in low temperature range about 600-800° C. The high-temperature phase, H—Nb₂O₅, is usually obtained by heating any other forms in air to approximately 1100° C. T-Nb₂O₅ belongs to the orthorhombic crystal family with space group Pbam. Its structure is similar to the classic tetragonal tungsten bronze (TTB) but composed of distorted octahedrons and pentagonal bipyramids rather than regular octahedra. The polyhedra are edge or corner sharing within the (001) plane and exclusively by corner sharing along the direction. A facile two-dimensional (2D) lithium-ion diffusion pathway in T-Nb₂O₅ has been identified recently by different theoretical and experimental methods. It was found that lithium diffusion is hindered by a high diffusion barrier along z direction and lithium can only intercalate into (001) plane since it has lowest niobium occupancy. This diffusion path topology throughout the entire structure of T-Nb₂O₅ forms a quasi-2D network for a fast Li-ion transport. H—Nb₂O₅ is a monoclinic crystal structure and is assigned to the space group P2/m or P2. The H-phase fits into CS structures with (3×4)₁ and (3×5)_{∞} ReO₃-like blocks of octahedra in the xz plane and infinite in the third dimension. These two blocks of different sizes are built up of corner sharing octahedra and are joined between them by edge sharing octahedra. The remaining tetrahedra are only connected with the two blocks by corner sharing polyhedra.

Experimentally, commercial Nb₂O₅ hydrates were used as the starting materials to study the calcination temperature effect on its structure properties and electrochemical performances.

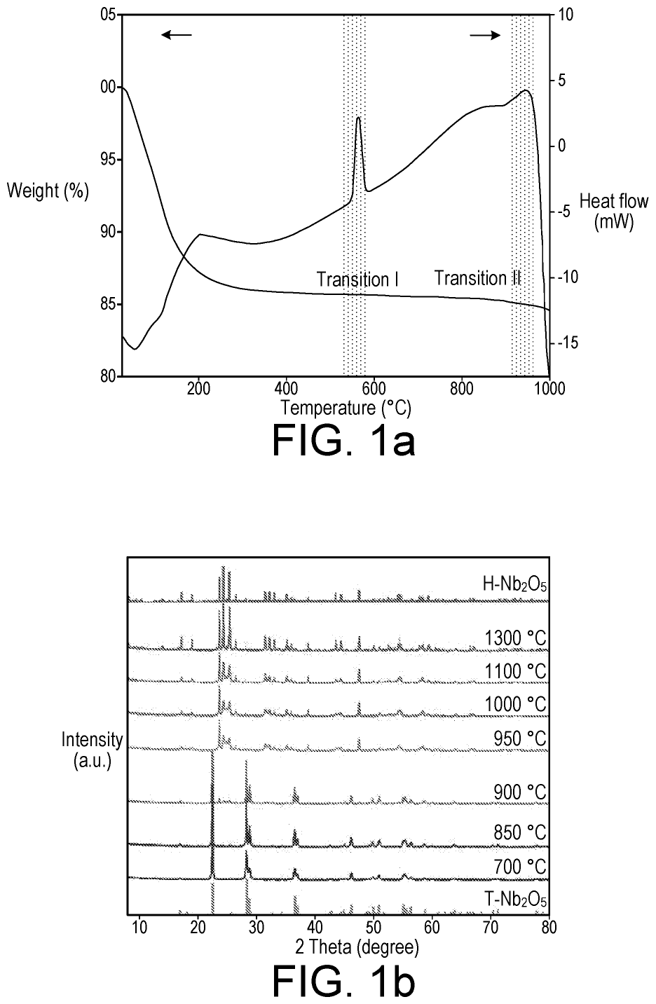

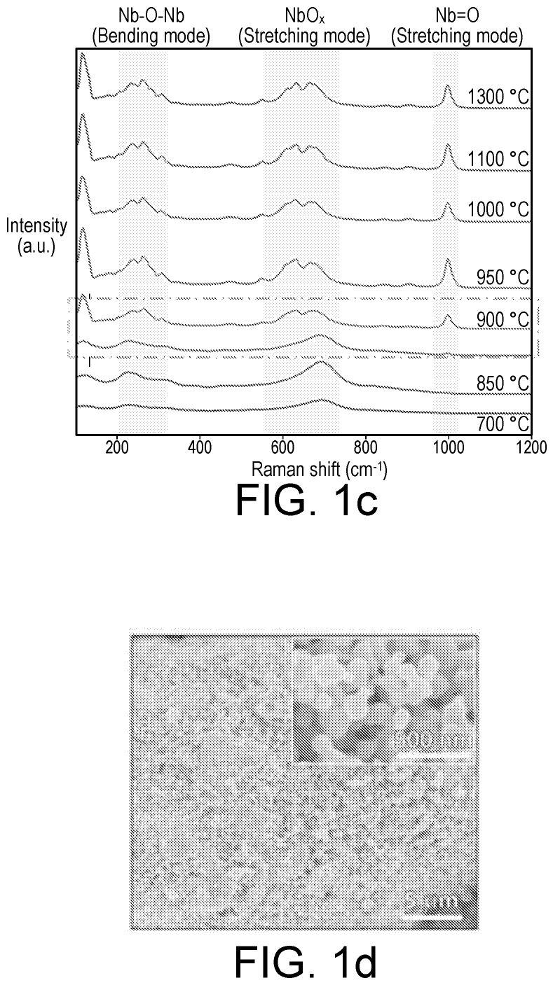

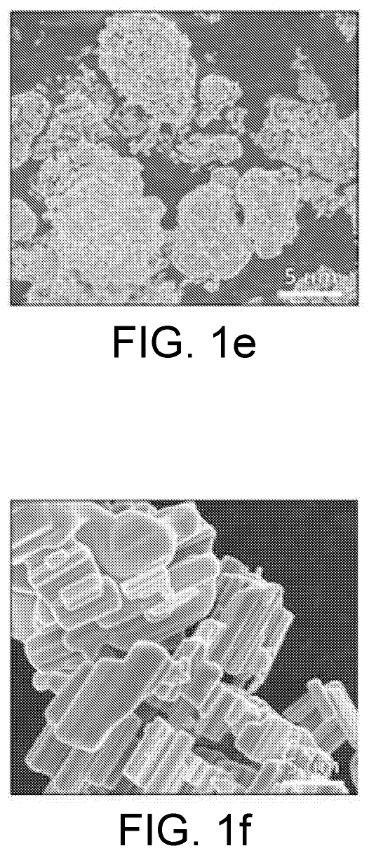

Thermogravimetric analysis (TGA) shows the weight of Nb₂O₅ hydrate becomes stable at around 200° C. (as shown in FIG. 1a). Differential scanning calorimetry (DSC) shows an endothermic peak ends at this point corresponding to the end of loss of crystal water. The first obvious exothermic peak at ˜570° C. in the heat flow corresponds to the transition from amorphous Nb₂O₅ to T-Nb₂O₅. The second phase transition at around 950° C. is assigned to the transformation from T-Nb₂O₅ to H—Nb₂O₅. The broad exothermic peak indicates the second transition is a kinetically sluggish process. Based on the TGA results, we set a series of temperature points that is higher than 700° C. to prepare different Nb₂O₅ samples. X-ray diffraction (XRD) reveals that Nb₂O₅ crystallizes in T-phase at the temperature lower than 850° C. (as shown in FIG. 1b). A second phase appears at 900° C. and the transition is completed after 950° C., which is consistent with the DSC analysis. The samples in the temperature range from 950° C. to 1100° C. show a similar characteristic diffraction pattern of H-phase. However, compared with pure H—Nb₂O₅ observed at 1300° C., notable difference in XRD of 950° C. sample was retained even after considering particle size and preferred orientation of crystal growth. Their similar high-angle diffraction region in XRD patterns indicate nearly identical short-range motifs while distinct low-angle diffraction region suggests different atomic arrangements on the long-range scale. As shown in FIG. 1c, the broader Raman band for T-Nb₂O₅ is due to the coexistence of two different niobium coordinations (NbO₆ and NbO₇) in the crystal structure. Except for the bending mode of Nb—O—Nb linkage at 200-300 cm⁻¹ and stretching mode of NbOₓ at ˜690 cm⁻¹, a new peak appears for H—Nb₂O₅ corresponding to the stretching mode of a higher-order bond (Nb═O terminal bond) with shorter bond distance. The Raman features for H—Nb₂O₅ prepared at different temperatures (e.g. 950° C. and 1300° C.) are highly similar indicating their local bonding is almost the same, consistent with XRD results. The Raman spectra of the samples calcined at 900° C. show characteristic peaks of either H-phase or T-phase as the laser focused on different regions, confirming the phase transition starts in this temperature range. SEM images show that starting from nano-sized hydrate, the particle size of Nb₂O₅ increased with increasing the calcination temperature (as shown in FIGS. 1d-1f). The material starts to sinter at 900° C. and finally becomes bulk at 1300° C., resulting in different surface areas. Growth and intergrowth of the original nano-particles of amorphous Nb₂O₅ produce corresponding aggregates of H—Nb₂O₅ with the size of several microns to tens of microns.

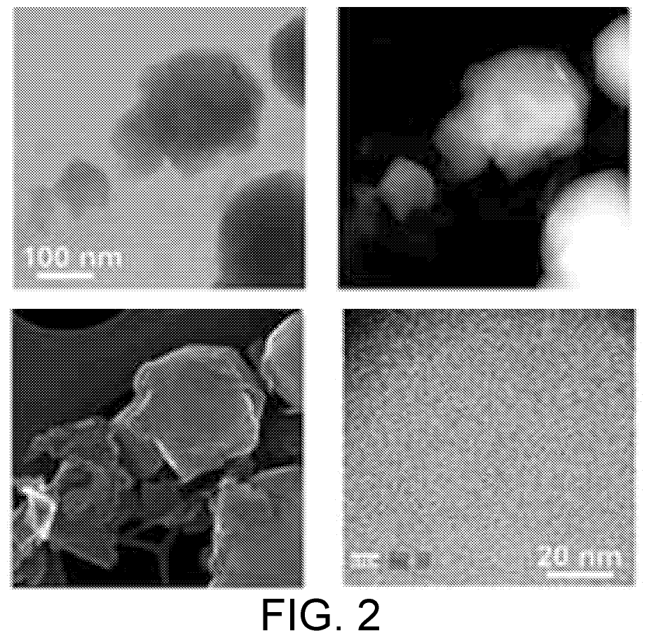

Fabrication and testing of a high-performance Nb₂O₅-graphite composite anode: Based on the above results, Nb₂O₅/graphite composites were further constructed using ball-mill method to mix Nb₂O₅ hydrate with commercial graphite, followed by calcination in Ar. The carbon content of the composite could be easily adjusted by adding the desired amount of graphite during the ball milling. Raman profiles show the typical peaks of graphite (above 1200 cm⁻¹) and amorphous Nb₂O₅ (below 800 cm⁻¹) for the mixture and new peaks appear at identical position as pure H—Nb₂O₅ (950° C.) after calcination. From SEM images, as shown in FIG. 2, it could be noted that the ball milling process result in a homogeneous mixture of graphite and Nb₂O₅ hydrate and the homogeneous distribution of graphite was remained in the composite after calcination. The addition of less than 10 wt % graphite further confined the growth of the size of Nb₂O₅ particles at 950° C. The particle size of Nb₂O₅ is around 400 nm, even smaller than the cellular of favose H—Nb₂O₅ (950° C.). A portion of graphite flasks connect the Nb₂O₅ particles in between and a portion occupy the cavities of the honeycomb, giving an ideal electric contact between the active materials.

When the as-prepared composite was used as anode material for LIBs, it exhibits a similar charge-discharge curve with H—Nb₂O₅ (950° C.). The only difference compared with pure H—Nb₂O₅ could be more easily observed from dQ/dV plots of the composite. A notable redox peak at 1.1˜1.2 V region appears for the composites, contributing some extra capacity. The anodes delivered a much higher capacity than H—Nb₂O₅ (950° C.) at every current density. A specific capacity of 245 mAh g⁻¹ was achieved at 0.5 C and 145 mAh g⁻¹ was achieved at 50 C. The composite shows a much higher capacity than most of state of art Nb-based oxides and composites at various current densities. Besides, an excellent durability was reflected by a high capacity over 140 mAh g⁻¹ even could be maintained after 2000 cycles at a high rate over 10 C and 30 C.

The rate performance of the composite was also investigated by changing potential window. Lowering cutoff voltage by 0.2 V reduces the capacities by 50 mAh g⁻¹ at 0.5 C. With increasing the rate, this value became smaller and reach almost same eventually. In contrast to T-Nb₂O₅, H-phase and its composites maintain a better stability and higher capacity in terms of switching potential windows, benefits for obtaining higher energy densities when employed as the anode of the full cell. The rate capability and capacity were not easily influenced by the amount of graphite by a linear relationship. Although the addition of 0.1 or 0.2 g of graphite enhances the initial capacity, the performance at high rate exhibits lower capacity than pure H—Nb₂O₅.

Annealing of Nb₂O₅ hydrate in Ar reduces the capacity of H—Nb₂O₅ slightly though the rate capability retained similar tendency. The addition of graphite does not just play a role on the conductivity like Super P or the other coating carbon. Nonlinear variation of the capacity as the quality of carbon addition also indicates that the carbon content of the composite not just impacts the overall electric conductivity, as the homogeneity of the structure and the particle size of Nb₂O₅ could be influenced as well. The defect and vacancies of Nb₂O₅ would also be affected by the amount of graphite added into the composites in inert atmosphere, resulting in different conductivity and even the phase of Nb₂O₅ in this composite. With respect to pure H—Nb₂O₅, a smaller ohmic polarization could be observed in charge-discharge curve of Nb₂O₅/graphite composite (950° C.). This could be attributed to the improvement of conductivity, one of the function of graphite addition. The capacity comes from graphite could be neglected since the cutoff voltage is above 1.0 V, where the contribution of graphite is almost zero. Also, the addition of 0.1 to 0.3 g of graphite does not influence the initial capacity, indicating that it does not play any role in terms of initial capacity. Instead, the capacity of Nb₂O₅/graphite composite (950° C.) could be reversible during charge-discharge and maintained very well even at high rate further confirming it just originates from the Nb₂O₅ of the composite itself.

Through a simple thermal oxidation of commercial Nb₂O₅ hydrate, one can prepare H—Nb₂O₅ with a different morphology so that it has high intercalation capacity, superior rate capability and cycling stability. The comparable ionic conductivity and better electronic conductivity of H—Nb₂O₅ explains why it has a faster lithium storage phenomenon than T-Nb₂O₅. The tenacity of H—Nb₂O₅ for extending potential window giving it higher capacity without stability deterioration and capacity loss, could contribute to a higher energy density than T-Nb₂O₅. By short processing time low sintering temperature at 950° C., a honeycomb-shaped structure of H—Nb₂O₅ was built, which gives a better utilization of the active site of the materials resulting in a high electrochemical performance among all H—Nb₂O₅. Moreover, a graphite/Nb₂O₅ composite can be constructed by simple ball milling and a calcination process. The composite anode materials exhibit significantly enhanced electrochemical performance over H—Nb₂O₅ in terms of specific capacity and rate capability, superior to those of state-of the art niobium-based anode materials or composites.

For this application, the temperature is important. At the temperature region close to 950° C., the shear structure with defects is obtained while maintaining the lithium diffusion tunnel. A minimized particle size of shear phase is also obtained at this temperature. Thus their performance is superior. Also, the addition of graphite of hydrate precursor produced a non-stoichiometric niobium oxide/graphite composite with higher performance

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112 (f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of making an electrode, comprising the steps of:
(a) dissolving a binder in a solvent to form a solution;
(b) suspending a Nb₂O₅ hydrate-based electrode material powder in the solution to form a slurry;
(c) dispensing a predetermined thickness of the slurry onto a conductive member so that the slurry has a mass loading in a range of 1 mg cm⁻² to 2 mg cm⁻²; and
(d) drying the conductive member and the slurry to form the electrode.

2. The method of claim 1, wherein the binder comprises PVDF.

3. The method of claim 1, wherein the solvent comprises 1-methyl-2-pyrrolidone.

4. The method of claim 1, wherein the Nb₂O₅ hydrate-based material further comprises a carbon composite.

5. The method of claim 4, wherein the carbon composite is made according to the steps of:
(a) adding graphite to Nb₂O₅ for form a mixture;
(b) ball milling the mixture to form an active powder;
(c) calcinating the active powder at a predetermined temperature and a predetermined ramp-up rate in a furnace to form a calcinated material; and
(d) grinding the calcinated material to form a graphite-modified Nb₂O₅ composite electrode material powder.

6. The method of claim 5, wherein the Nb₂O₅, the carbon and the binder have a mass ratio of 8:1:1.

7. The method of claim 5, wherein the predetermined temperature is about 950° C. and the predetermined ramp-up rate is about 5° C.⁻¹.

8. The method of claim 5, wherein the calcinating step includes heating the active powder at the predetermined temperature for about 3 hours in a substantially inert atmosphere.

9. The method of claim 8, wherein the substantially inert atmosphere comprises argon gas.

10. The method of claim 5, wherein the ball milling step comprises rotating the mixture at about 500 rpm for 2 hours.

11. The method of claim 1, wherein the predetermined thickness is about 20 μm.

12. The method of claim 1, wherein the drying step comprises the steps of:
(a) drying the conductive member in air at about 70° C. for about 30 minutes; and
(b) then placing conductive member in a vacuum oven at about 90° C. for about 8 hours.

13. The method of claim 1, wherein the conductive member comprises a copper foil.

14. A battery, comprising:
(a) an anode including a graphite-modified Nb₂O₅ composite electrode material powder;
(b) a cathode;
(c) an electrolyte in electrical communication with the anode and the cathode; and
(d) a separator that is permeable to the electrolyte and that is dispose between the anode from the cathode.

15. The battery of claim 16, wherein the electrolyte comprises lithium hexafluorophosphate (LiPF₆) in ethylene carbonate/dimethyl carbonate.

16. The battery of claim 14, wherein the conductive member comprises a copper foil and wherein the anode is made according to the following process steps:
(a) adding graphite to Nb₂O₅ for form a mixture;
(b) ball milling the mixture to form an active powder;
(c) calcinating the active powder at a predetermined temperature and a predetermined ramp-up rate in a furnace to form a calcinated material;
(d) grinding the calcinated material to form a graphite-modified Nb₂O₅ composite electrode material powder;
(e) dissolving PVDF in 1-methyl-2-pyrrolidone to form a solution;
(f) suspending the composite electrode material powder in the solution to form a slurry;
(g) dispensing a predetermined thickness of the slurry onto the copper foil so that the slurry has a mass loading in a range of 1 mg cm⁻² to 2 mg cm⁻²; and
(h) drying the conductive member and the slurry to form the electrode.

17. The battery of claim 16, wherein the predetermined temperature is about 950° C. and the predetermined ramp-up rate is about 5° C.⁻¹.

18. The battery of claim 16, wherein the calcinating step includes heating the active powder at the predetermined temperature for about 3 hours in an argon gas atmosphere.

19. The battery of claim 16, wherein the predetermined thickness is about 20 μm.

20. battery of claim 16, wherein the drying step comprises the steps of:
(a) drying the conductive member in air at about 70° C. for about 30 minutes; and
(b) then placing conductive member in a vacuum oven at about 90° C. for about 8 hours.
